(19) United States
(12) Patent Application Publication
(10) Pub. No.: US 2022/0038774 A1
(43) Pub. Date: Feb. 3, 2022

(54) SYSTEM AND METHOD FOR RECORDING VIEWER REACTION TO VIDEO CONTENT

(71) Applicant: ARRIS ENTERPRISES LLC, Suwanee, GA (US)

(72) Inventors: Gabriel Sigüenza Paz, General Escobedo (MX); Alfredo De La Llata Ayala, Escobedo (MX)

(73) Assignee: ARRIS ENTERPRISES LLC, Suwanee, GA (US)

(21) Appl. No.: 17/361,833

(22) Filed: Jun. 29, 2021

Related U.S. Application Data
(60) Provisional application No. 63/057,682, filed on Jul. 28, 2020.

(51) Int. Cl. H04N 21/442; H04N 21/4223; H04N 21/431; H04N 5/45

(52) U.S. Cl. CPC H04N 21/44218; H04N 5/45; H04N 21/4316; H04N 21/4223

(57) ABSTRACT

A system and method for automatically recording viewer reactions to viewed video content. The system and method utilize a system that responds to pre-tagged segments of video content. Upon recognition of such a tagged segment, a video camera is activated to capture the viewer response. A composite video of the captured viewer response and the segment of viewed video is then created. The viewer is notified that the composite video has been created. The system and method also provide the viewer with options to share the video via social media.

### CROSS-REFERENCE TO RELATED APPLICATION

This application claims the benefit of U.S. Provisional Patent Application 63/057,682, filed Jul. 28, 2020, which is incorporated by reference herein in its entirety.

### BACKGROUND OF THE INVENTION

The ever-increasing use of social networking as a means of creating new personal associations or maintain contact with friends and family is changing the manner in which people interact with one another. These networks are utilized to for one-on-one chatting, large gatherings and virtual cocktail hours, as well as the sharing of photos and videos. For many users, social networking services have become the primary means of personal interaction with a significant segment of their social circle.

Consequently, it would be desirable for users of such services to create personalized media content suitable for sharing with their social media contacts. In particular, it would be advantageous to share personalized media related to an event that might have been shared by others within a user's social media contacts. For example, if the members of a particular group of individuals that maintained contact via social media all enjoyed viewing televised professional soccer events, it would be desirable for those individuals to create personalized media content that directly related to such events. The same would be true for members of a social media group that enjoyed watching classic movies. Personalized video content related to that genre of film would likely be of value. Sharing such content among the members of the various groups would help to create a commonality among the members of the group, and thereby making a video experienced separately by each of the individuals become a shared experience.

Although one or more camera could arguably be positioned to capture the video content being watched and the reactions of one or more individuals viewing the video, configuring such a system would be a significant task. In addition, the user would then need to edit the captured content to capture the particular moments of significant viewer reaction and create a split-screen or other composite view showing the video image and the related viewer reaction. This type of complex and time-consuming procedure simply does not lend itself to creating personalized media content that a user would be able to easily share via social media, especially if it was desirable to share the content immediately after the particular video event was viewed and the viewer reaction recorded.

Consequently, there exists a need for a system that automatically records a viewer's reaction to significant video events and creates personalized video content therefrom.

### BRIEF SUMMARY OF THE INVENTION

A system and method for automatically recording viewer reactions to viewed video content. The system and method utilize a system that responds to tagged segments of video content. Upon recognition of such a tagged segment, a video camera is activated to capture the viewer response. A composite video of the captured viewer response and the segment of viewed video is then created. The viewer is notified that the composite video has been created. The system and method also provide the viewer with options to share the video via social media.

### BRIEF DESCRIPTION OF THE DRAWINGS

The aspects, and advantages of the present invention will become better understood with regard to the following description, appended claims, and accompanying drawings in which:

FIG. 1 is a is a functional block diagram of a system supporting a first preferred embodiment of an automatic system for recording viewer reactions.

FIG. 2A is a view of a screen displaying a first composite video.

FIG. 2B is a view of a screen displaying a second composite video.

FIG. 2C is a view of a screen displaying a third composite video.

FIG. 3 is process flow diagram of for a preferred embodiment of a process for automatically recording viewer reactions to video content.

FIG. 4A is a view of a screen providing a first visual indicator to a viewer.

FIG. 4B is a view of a screen providing a second visual indicator to a viewer.

FIG. 4C is a view of a screen providing a third visual indicator to a viewer.

### DETAILED DESCRIPTION

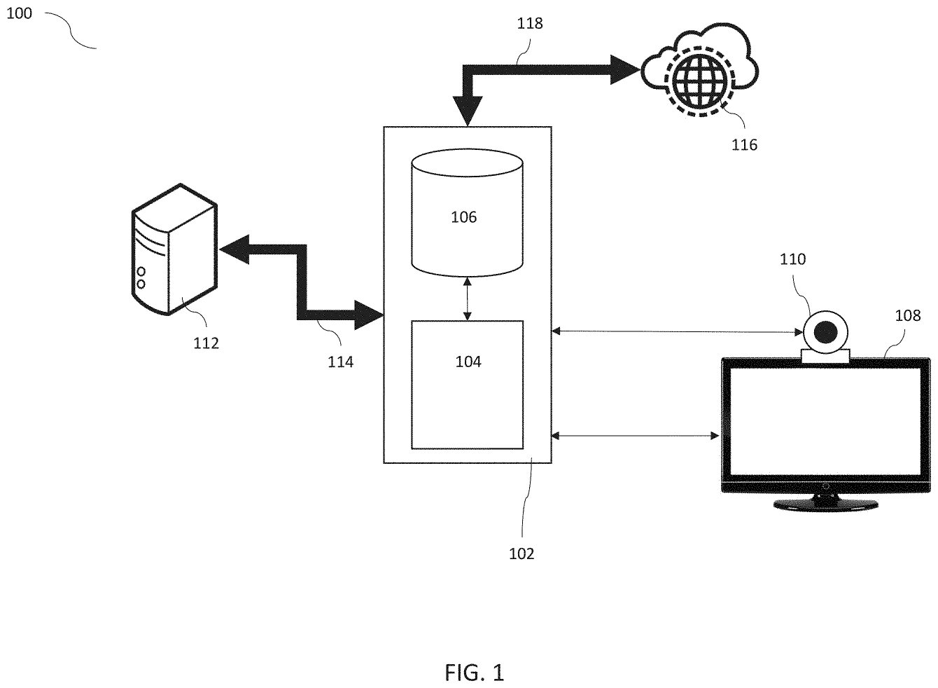

FIG. 1 is a functional block diagram of a preferred embodiment of a media appliance enabling the automatic recording of viewer reaction to a video event. As shown, the system 100 comprises media appliance 102 which is adapted to manage the transmission, reception, recording, storage and viewing of multiple types of digital media and digital communications. Gateway appliance 102 includes processor 104 and memory 106. Processor 104 is also shown to be in communication with television 108 and digital video camera 110. In addition, gateway appliance 102 is linked to multiservice operator (“MSO”) 112 by broadband connection 114, and to the Internet (116) via broadband connection 118.

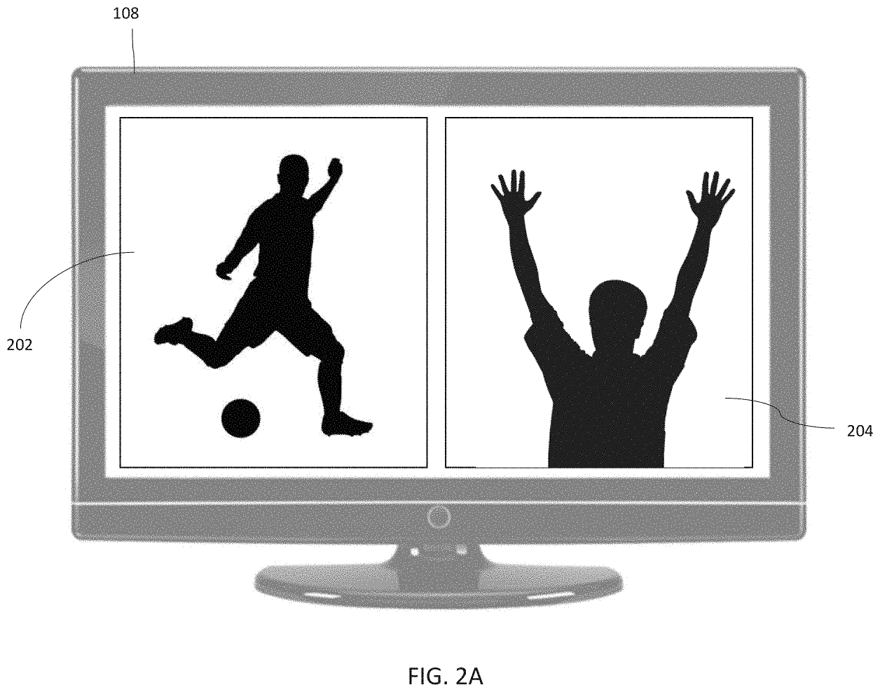

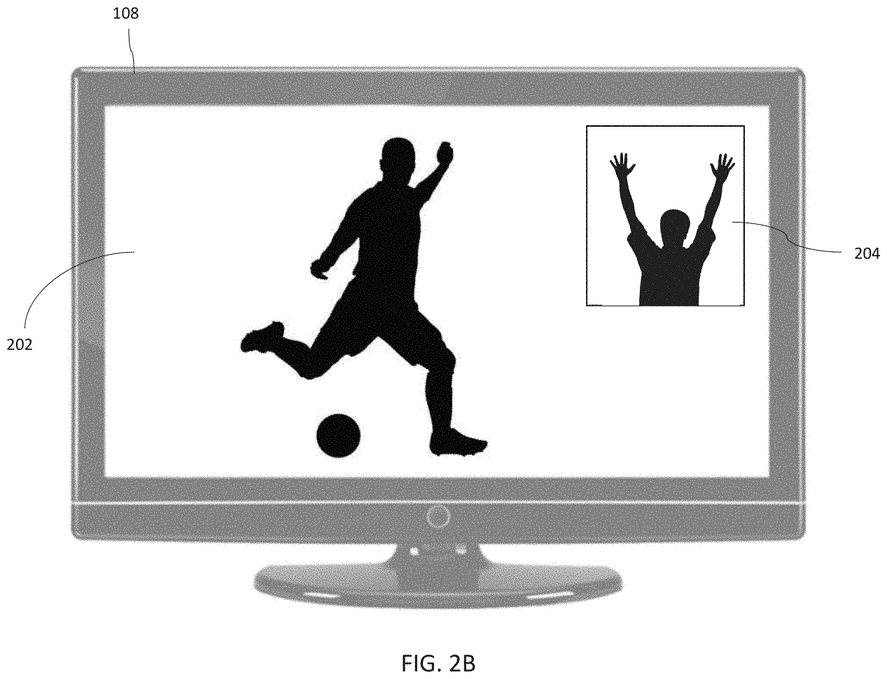

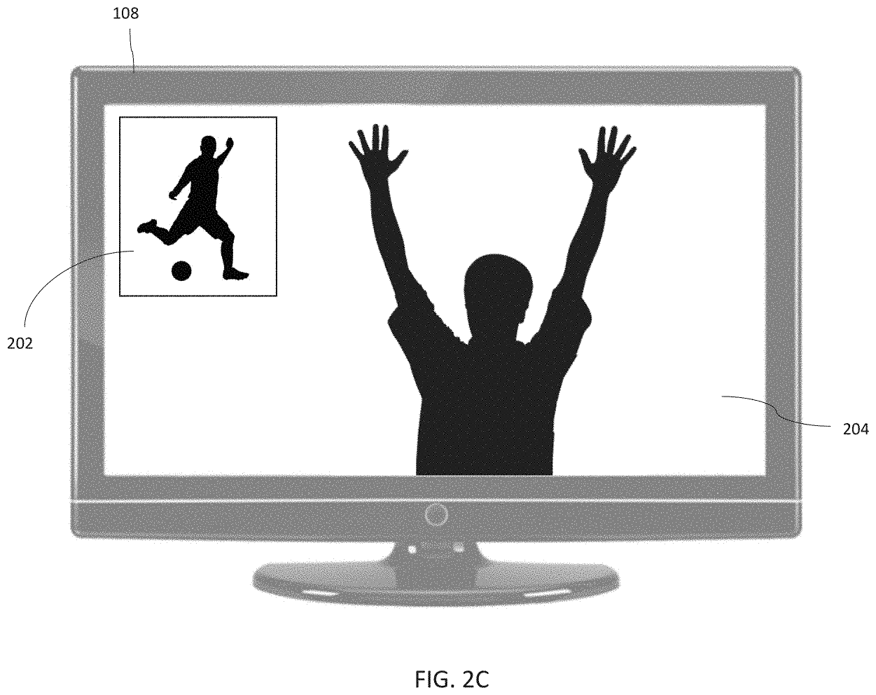

Video content received by gateway appliance from MSO 112 or the Internet 116, or played from recorded content stored in memory 106 is viewed upon television 108. Camera 110 is placed so that is records images and sound from an area where individuals watching television 108 would be situated. Camera 110 can be a stand-alone device, or integrated into either television 108 or gateway appliance 102. As video content is played upon television 108, processor 104 receives real-time video from camera 110. The video from camera 110, capturing viewer reaction to what is being displayed on television 108, is stored within memory 106. In addition, processor 104 also causes a recording of the video being displayed on television 108 to be stored in memory 106. These two video recordings are time-stamped so as to permit processor 104 to synchronize the video content received from camera 110 with the video that was being shown on television 108. Processor 104 then creates a composite video of the recorded viewer reaction and the video displayed upon television 108. This composite can be a split-screen view showing the viewed content 202 and the viewer reaction 204 (FIG. 2A), or a picture-in-picture (FIGS. 2B and 2C) presentation of the viewer's reaction. The particular format can be determined by the content provider or by user preference.

Although the above described system would provide a user with a composite view of a video event and their reaction to it, it would not be a practical means of providing personalized media content that could be conveniently shared with others via social media. Users would likely not want to attempt to send a video of themselves watching a 90-minute movie to share their reaction to a particularly significant scene that lasted only a few minutes or seconds and occurred over an hour into the movie. The same would be true for sharing the reaction to a goal during a soccer match. Sending the entire game to a friend via social media isn't particularly useful.

The present system overcomes this problem by utilizing tagged video and embedded camera commands. A video content provider, such as an MSO or Internet content provider, will embed a key tag within the video (recorded or streamed) to identify segments of the video that the provider considers likely to generate a significant viewer reaction (hero rescues imperiled victim, goal scored with one-second left to play; etc.). Each key tag would include information indicative of the duration of the identified video segment. The indicated duration defines a fixed interval over which viewer reaction should be recorded. These key tags could be embedded as particular packet identifiers (“PIDs”) within MPEG-encoded video content.

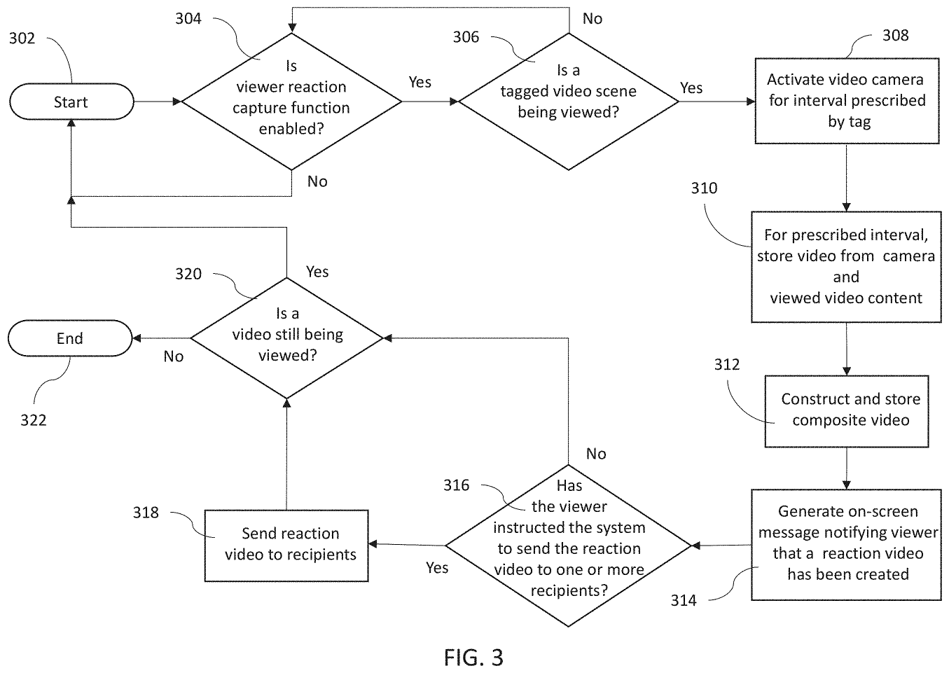

As shown in FIG. 3, processor 104 determines if a user has enabled the reaction recording feature of gateway appliance 102 (steps 302 and 304). If the feature has been enabled the process continues with step 306 and processor 104 engages in the process of recognizing tagged scenes in the video being viewed on television 108. In step 308 processor 104 activates camera 110 for the interval prescribed by tag. The video captured by camera 110 and the video being displayed on television 108 during that prescribed interval are stored in memory 106 (step 310). Processor 104 then creates a composite video (split-screen, picture-in-picture) showing both the user reaction and the viewed video, and stores in in memory 106 (step 312). This composite video would typically have a duration measured in seconds; lasting only long enough to capture the viewer reaction to the tagged event. The viewer is then notified that a reaction video has been created by an on-screen message generated by processor 104. (step 314). Processor 104 then determines if a viewer has indicated that the composite video should be sent to one or more recipients (step 316). If so, the video is transmitted by processor 104 to the intended recipient(s) via broadband connections 114 or 118 (step 318). If not, the processor determines if a video is still being viewed on television 108 (step 320). If so, the process continues with step 202; if not, the process terminates (step 322).

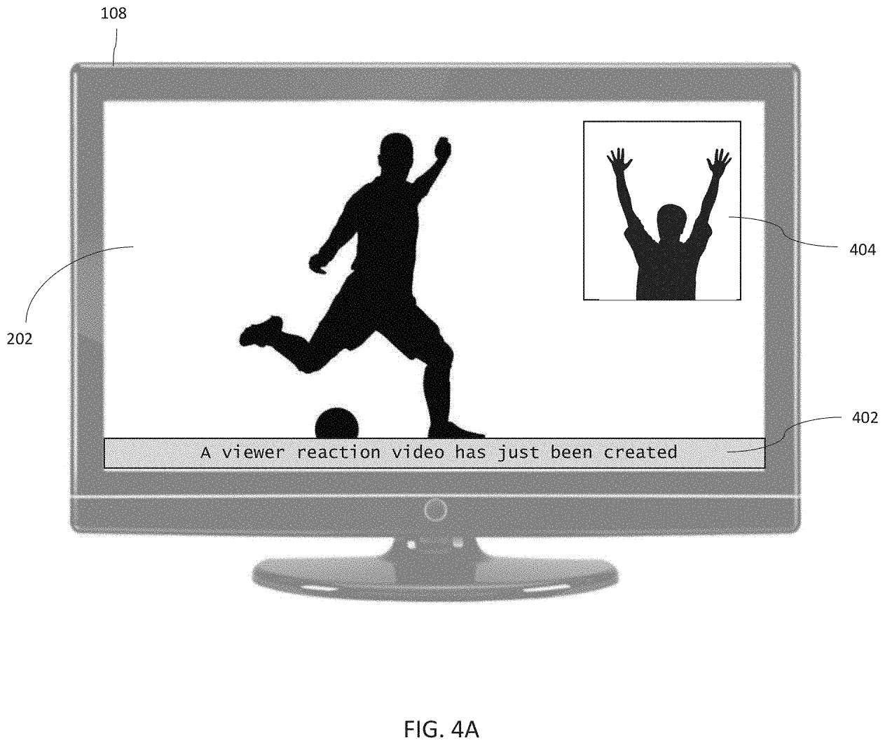

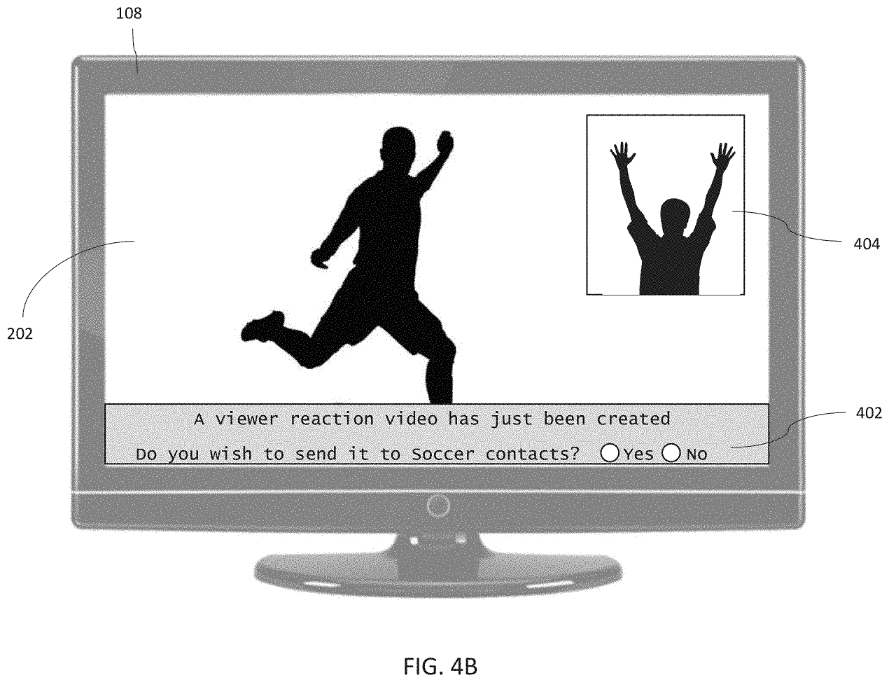

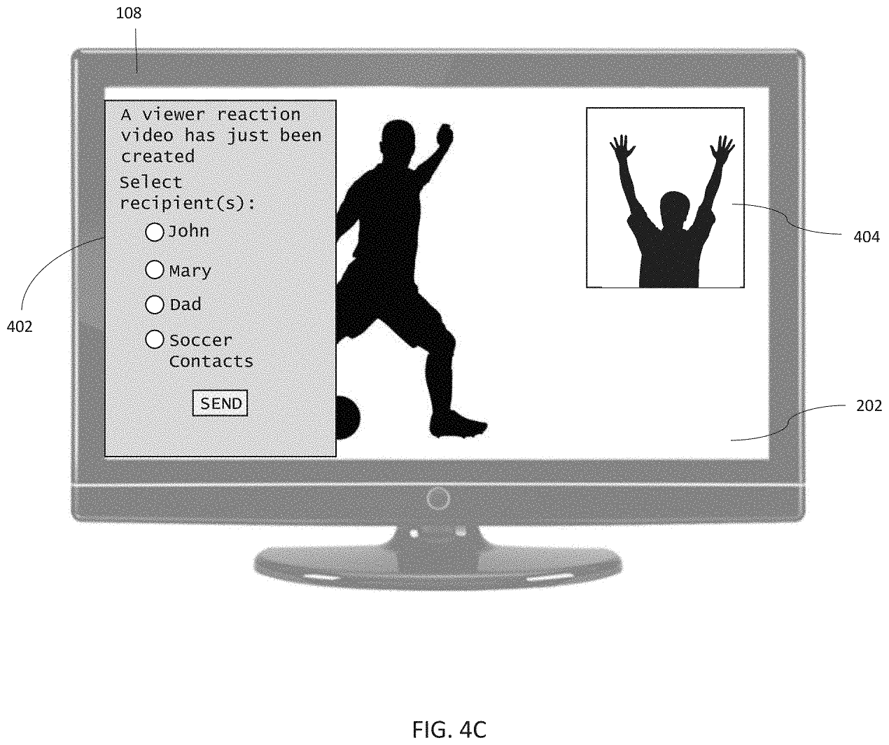

Once the composite video was stored in memory 106, processor 104 generates an alert (such as a pop-up or a crawler) on the screen of television 108 informing the viewer that their reaction had just been captured (step 214). An example of an on-screen alert (402) is provided in FIG. 4A. The on-screen alert could also be accompanied by a brief preview of the captured viewer reaction presented as a picture-in-picture (404). This on-screen alert could also provide a viewer with an option to send the captured viewer reaction to a predetermined contact or contacts (FIG. 4B), or permit a viewer to select recipients from an on-screen contact list (FIG. 4D).

The tagging of particular scenes in content that would be stored for later broadcast or on-demand streaming would be a straight-forward process. A person or an artificial-intelligence (“AI”) system would review the content and insert tags where deemed appropriate. The particular insertions could be based upon prior knowledge of the location within a particular content of pivotal scenes, or based upon the detection of information within the video content that was representative of drastic changes in the picture (possibly indicative of an explosion or a chase). The placement of tags by the provider could also be a function of which previously recorded viewer reaction videos a user chose to keep or share. If a user consistently shared their reaction to romantic scenes, the provider could weigh the insertion of tags to similarly romantic scenes in future content. Likewise, if a viewer consistently shared scenes where a monster appeared, their tags could be weighted to favor shocking content.

A provider could also tag live video feeds either by introducing a delay that would permit a person or persons to tag scenes (such as goals during a soccer match) prior to the video being sent to viewers, or employ an AI system to identify scenes for tagging in a manner that would introduce a negligible delay. Although the invention herein has been described with reference to particular embodiments, it is to be understood that these embodiments are merely illustrative of the principles and applications of the present invention. For example, storage of video captured by camera 110 and/or of the tagged video viewed on television 108 could be stored in a drive external to gateway appliance 102, including remote storage systems connected to the gateway appliance via public or private networks, including the Internet. In addition, television 108 is merely one example of a screen upon which the invention can utilize. It will be understood that numerous types of screens and viewing devices could be employed, including, but not limited to: smartphones, tablets, computer monitors, etc. In addition, the gateway appliance 102 can be a stand-alone device such as a set-top box, or integrated into another system or device such as a television or a computer. All of the above variations and extensions could be implemented and practiced without departing from the spirit and scope of the present invention as defined by the appended claims.

1. A system for recording reaction to viewed a video, the system comprising:
at least one display adapted to present a digital video comprising at least one video segment associated with a tag, wherein the tag identifies the video segment as likely to generate a significant viewer reaction and provides information indicative of the duration of the identified video segment;
at least one camera adapted to record images of at least one individual situated to watch the at least one video monitor;
a memory adapted to store digital video information; and
at least one processor adapted to:
detect the tag associated with the at least one video segment as the at least one video segment is being presented upon the at least one video display;
activate the camera, in response to the detection of the tag, to record video during for the duration of the at least one video segment;
store the at least one video segment and the video recorded by the camera during the at least one video segment in the memory;
combine the at least one video segment and the video recorded by the camera during the at least one video segment to create a composite video; and
store the composite video in the memory.

2. The system of claim 1 wherein the composite video comprises at least one of the following:
a split screen simultaneously displaying the at least one video segment and the video recorded by the camera during the at least one video segment;
a picture-in-picture comprising the video recorded by the camera during the at least one video segment displayed as a picture-in-picture upon the at least one video segment; and
a picture-in-picture comprising the at least one video segment displayed as a picture-in-picture upon the video recorded by the camera during the at least one video segment.

3. The system of claim 1 wherein the tag comprises an MPEG packet identifier.

4. The system of claim 1 wherein the at least one camera is an integral component of at least one of the following:
the at least one display; and
a set-top box.

5. The system of claim 1 wherein the tag associated with the at least one video segment comprises an MPEG packet identifier.

6. The system of claim 1 wherein the tag associated with the at least one video segment was applied based upon at least one of the following:
human review of the digital video by a human; and
analysis of the digital video by an automated system.

7. The system of claim 1 wherein the tag comprises an MPEG packet identifier.

8. The system of claim 1 wherein the processor is further adapted to generate a visual indicator upon the at least one display video indicative of the creation of the composite video.

9. The system of claim 8 wherein the visual indicator comprises at least one of the following:
a preview of the video recorded by the camera; and
a prompt for enabling the sharing of the composite video via a network.

10. The system of claim 9 wherein the prompt comprises a list of at least one recipient with which the composite video can be shared.

11. A method for recording reaction to viewed a video in a system comprising:
at least one display adapted to present a digital video comprising at least one video segment associated with a tag, wherein the tag identifies the video segment as likely to generate a significant viewer reaction and provides information indicative of the duration of the identified video segment;
at least one camera adapted to record images of at least one individual situated to watch the at least one video monitor;
a memory adapted to store digital video information; and
at least one processor adapted:
The method comprising the steps of:
detecting the tag associated with the at least one video segment as the at least one video segment is being presented upon the at least one video display;
activating the camera, in response to the detection of the tag, to record video during for the duration of the at least one video segment;
storing the at least one video segment and the video recorded by the camera during the at least one video segment in the memory;
combining the at least one video segment and the video recorded by the camera during the at least one video segment to create a composite video; and
storing the composite video in the memory.

12. The method of claim 11 wherein the composite video comprises at least one of the following:
a split screen simultaneously displaying the at least one video segment and the video recorded by the camera during the at least one video segment;
a picture-in-picture comprising the video recorded by the camera during the at least one video segment displayed as a picture-in-picture upon the at least one video segment; and
a picture-in-picture comprising the at least one video segment displayed as a picture-in-picture upon the video recorded by the camera during the at least one video segment.

13. The method of claim 11 wherein the tag comprises an MPEG packet identifier.

14. The method of claim 11 wherein the at least one camera is an integral component of at least one of the following:
the at least one display; and
a set-top box.

15. The method of claim 11 wherein the tag associated with the at least one video segment comprises an MPEG packet identifier.

16. The method of claim 11 wherein the tag associated with the at least one video segment was applied based upon at least one of the following:
human review of the digital video by a human; and
analysis of the digital video by an automated system.

17. The method of claim 11 wherein the tag comprises an MPEG packet identifier.

18. The method of claim 11 further comprising the step of generating a visual indicator upon the at least one display video indicative of the creation of the composite video.

19. The method of claim 18 wherein the visual indicator comprises at least one of the following:
a preview of the video recorded by the camera; and
a prompt for enabling the sharing of the composite video via a network.

20. The method of claim 19 wherein the prompt comprises a list of at least one recipient with which the composite video can be shared.
